(19) United States
(12) Patent Application Publication
(10) Pub. No.: US 2006/0258280 A1
(43) Pub. Date: Nov. 16, 2006

(54) Solar powered ventilation system

(75) Inventor: Randall E. Hagen, Starbuck, MN (US)

Correspondence Address: HAMRE, SCHUMANN, MUELLER & LARSON, P.C., P.O. BOX 2902, MINNEAPOLIS, MN, 55402-0902, US

(73) Assignee: Solar Skies, Inc., Starbuck, MN (US)

(21) Appl. No.: 11/186,074

(22) Filed: Jul. 21, 2005

Related U.S. Application Data
(60) Provisional application No. 60/669,258, filed on Apr. 7, 2005.

(51) Int. Cl. B60H 1/00

(52) U.S. Cl. 454/69

(57) ABSTRACT

A system for ventilating and cooling the interior of a parked vehicle. The system can be used on many types of vehicles including, but not limited to, aircraft, cars, trucks and the like. In one specific implementation, the system is used to ventilate and cool the interior of the cockpit of a general aviation aircraft, for example a single engine Piper Archer, while the aircraft is parked during non-use.

### CROSS-REFERENCE TO RELATED APPLICATIONS

The present application claims the benefit of U.S. Provisional Patent Application Ser. No. 60/669,258 filed on Apr. 7, 2005 and entitled “SOLAR POWERED VENTILATION SYSTEM”, and which is incorporated herewith by reference in its entirety.

### FIELD OF THE INVENTION

The invention relates generally to vehicle ventilation systems. In particular, the invention relates to a system for ventilating the interior of a vehicle, for example the cockpit of an aircraft.

### BACKGROUND OF THE INVENTION

A problem that is common to many types of parked vehicles, for example airplanes, cars, trucks, and the like, is excessive heating of the interior of the vehicle by the sun. Many vehicles are equipped with systems to keep the interior cool when the vehicle is moving. However, these systems may not be designed to function while the vehicle is parked and left out in sunlight. The sun's rays entering through windows of a stationary, parked vehicle can quickly heat the interior of the vehicle. The amount of heating that can occur can be significant, raising the interior temperature to a level that is uncomfortable for someone later entering the interior of the vehicle, and possibly to a level that can cause damage to systems and contents within the interior of the vehicle.

The cockpit of a general aviation aircraft, for example a single engine Piper Archer or a twin engine Piper Seneca, is one example of a vehicle where excessive heating can be problematic. Many general aviation aircraft have a relatively large amount of window area when compared to the window area on larger aircraft such as passenger jets. However, for general aviation aircraft, the large window area means more of the sun's rays can enter the cockpit when the aircraft is parked, thereby heating the interior of the cockpit. This problem is increased due to the fact that many general aviation aircraft are parked outside and away from shade, thereby fully exposing the aircraft to the full force of the sun's rays for extended periods of time.

As with a vehicle such as a car, heating of the interior of the cockpit can be uncomfortable for someone later entering the cockpit. Further, excessive heating within the cockpit of an aircraft can cause damage to mechanical and electrical components, for example sensitive avionics, of the aircraft, and cause damage to upholstery, plastics, and interior contents.

There is a need for a system to ventilate and cool the interior of a vehicle, for example the cockpit of a general aviation aircraft, while the vehicle is parked.

### SUMMARY OF THE INVENTION

The invention relates to a system for ventilating and cooling the interior of a parked vehicle. The system can be used on many types of vehicles including, but not limited to, aircraft, cars, trucks and the like. In one specific implementation, the system is used to ventilate and cool the interior of the cockpit of a general aviation aircraft, for example a single engine Piper Archer, while the aircraft is parked during non-use.

In one aspect of the invention, the system comprises an array of photovoltaic cells electrically connected to an exhaust fan. The photovoltaic cells convert sunlight energy into electrical energy for powering the exhaust fan. The exhaust fan is positioned to vent hot air from the interior of the vehicle to the exterior of the vehicle, thereby creating negative pressure in the interior to draw in cooler outside air into the interior, for example through the vehicle's vents.

When used on general aviation aircraft, the exhaust fan can, for example, be mounted within the pilot window often found on such aircraft. The photovoltaic cells are mounted in a position to be exposed to the sun rays, either inside the interior of the aircraft, for example in the cockpit, or on the outside of the aircraft. The system must also be removable to permit flight of the aircraft, as well as be compact so that it takes up minimal storage space within the aircraft and be light in weight so that it does not substantially diminish the aircraft's useful load.

### BRIEF DESCRIPTION OF THE DRAWINGS

Like reference numbers generally indicate corresponding elements in the Figures. The embodiments illustrated are exemplary only and are in accordance with the principles of the present invention.

FIG. 1 is a view of one embodiment of an array of photovoltaic cells shown in a portion of a cockpit area of an aircraft and for a ventilation system according to the invention.

FIG. 2 is a view of one embodiment of a ventilation system shown in the interior of the cockpit and showing one embodiment of an exhaust fan mounted in the pilot window of the cockpit.

FIG. 3A is a side view of the exhaust fan mounted in the pilot window and shown at the exterior of the cockpit area.

FIG. 3B is an elevational bottom view of the exhaust fan showing the air outlet.

FIG. 4 is a side view of the cockpit area from the exterior of the aircraft with the exhaust fan removed and the pilot window closed.

FIG. 5 illustrates an alternative embodiment of an exhaust fan mounted in the pilot window.

FIG. 6 is a detailed view of an area adjacent a hinge of the pilot window and at the interior of the cockpit.

FIGS. 7A, 7B, and 8 illustrate alternative locations for the photovoltaic cells.

FIG. 9 is a schematic view of one embodiment of a thermostat incorporated into an electrical cord assembly.

FIG. 10 is a schematic depiction of an electrical connection between the electrical cord assembly and the thermostat.

### DETAILED DESCRIPTION OF THE PREFERRED EMBODIMENT

The invention relates to a system 10 for ventilating and cooling the interior space 12 of a vehicle 14. For sake of convenience, the vehicle 14 will hereinafter be described as a general aviation aircraft, for example a single engine Piper Archer, and the interior space 12 will be described as the cockpit area of the aircraft. However, it is to be realized that the invention could be used to ventilate and cool the interiors of other vehicles, as well as ventilate and cool other interior spaces of an aircraft.

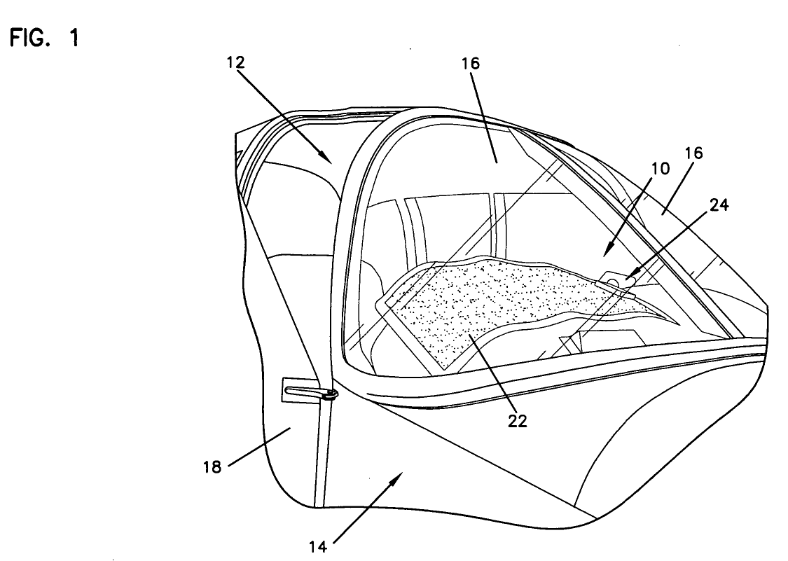

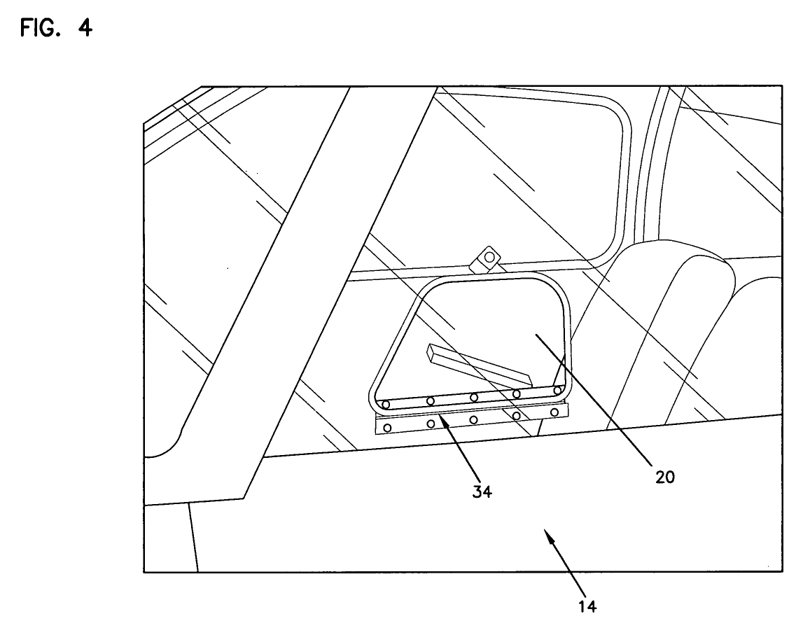

With reference to FIG. 1, the aircraft 14 includes front and side windows 16 as well as a door 18 that provides access to the interior of the cockpit 12. As shown in FIG. 4, the pilot side window 16 includes a smaller pilot window 20 (also called a call window or a vent window) that can be opened and closed. The pilot window 20 in FIG. 4 is shown in the closed position. Pilot windows similar to the window 20 are found on many types of general aviation aircraft. The invention can be adapted to be used in connection with a pilot window on any type of aircraft.

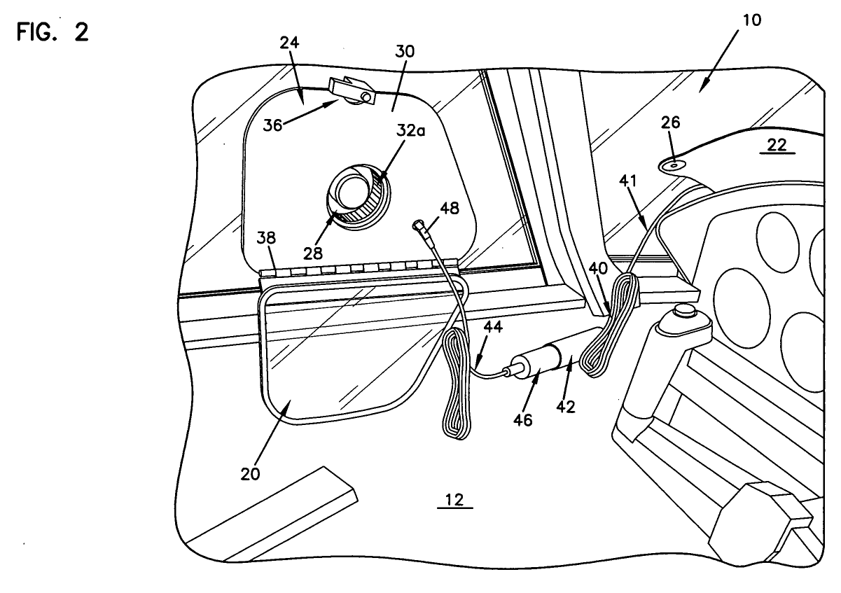

With reference to FIGS. 1 and 2, the system 10 comprises an array of photovoltaic cells 22 and an exhaust fan 24 that is mountable in the pilot window 20 when the pilot window is opened. The photovoltaic cells 22 are configured to generate electrical energy from sunlight, in order to operate the exhaust fan 24 by electric power. The exhaust fan 24 is configured to exhaust hot air from the interior of the cockpit 12 to the exterior. This creates negative pressure in the cockpit interior which draws in cooler outside air into the cockpit through the aircraft's vents (not shown) thereby cooling the interior of the cockpit.

Any type of photovoltaic cells 22 that can produce electrical energy can be used. In the illustrated embodiment, the array of photovoltaic cells 22 comprises a PowerFilm® solar panel available from Iowa Thin Film Technologies of Ames, Iowa. A PowerFilm® solar panel is flexible and allows the array 22 to be rolled up when not in use to minimize storage space.

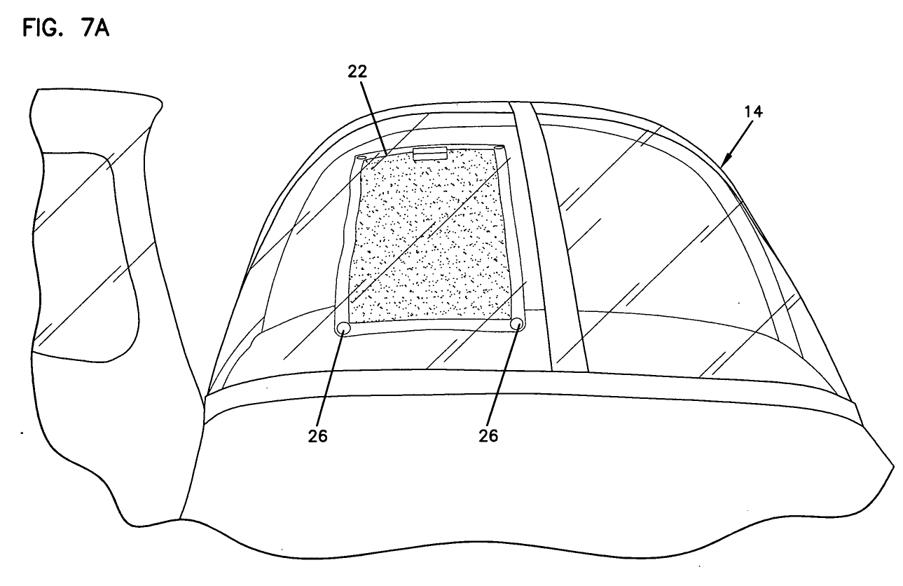

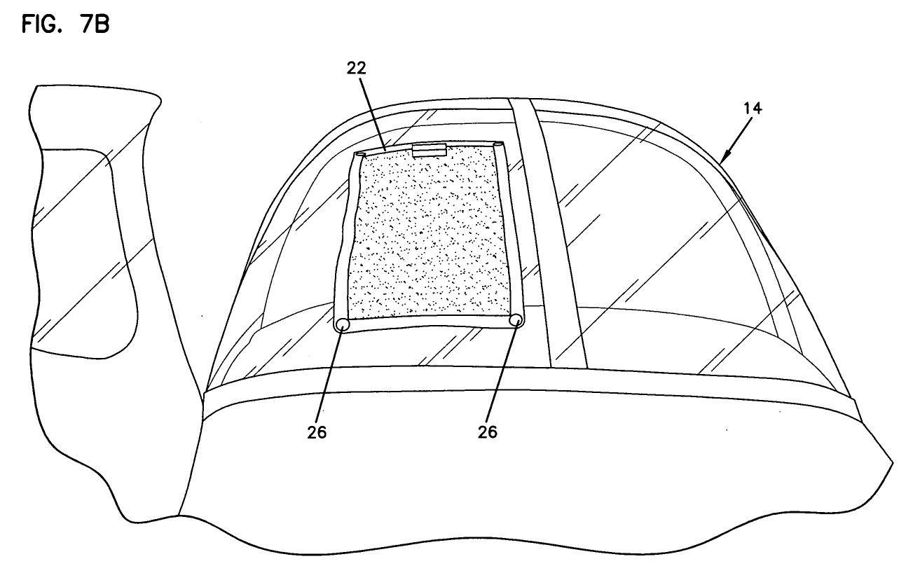

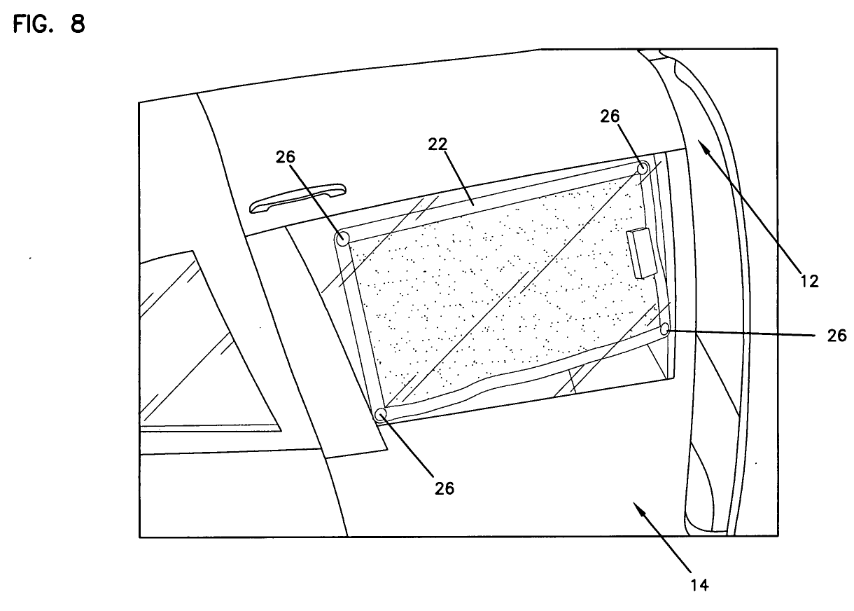

The array 22 is illustrated as being disposed inside the cockpit 12 with the photocells facing outward to be exposed to sunlight. FIG. 1 shows the array 22 disposed on the dashboard of the cockpit. FIG. 7A shows the array 22 disposed on the interior of one of the front windows of the aircraft. FIG. 8 shows the array positioned on the interior side of a side window of the aircraft. The array 22 could alternatively be disposed outside the aircraft at a suitable location, for example on the windshield (FIG. 7B) or on the engine housing.

It will be appreciated that the solar powered configuration and use of the array of photovoltaic cells is one preferred embodiment for generating electrical power. It will be appreciated that other sources of electrical power may be used that may also be suitable for powering the exhaust fan.

Securement means are provided to mount the array 22 in position. For example, when mounted inside the cockpit, suction cups 26 can be located at the corners of the array 22 for mounting the array to the interior surface of a window. When mounted outside the aircraft, suction cups could be used to mount the array to the exterior surface of a window or the exterior surface of the plane, or, if a cover is disposed over the aircraft, hook and loop fasteners can be used to secure the array 22 to the cover.

It will be appreciated that the securement means illustrated is exemplary only as other configurations of mounting the array 22 in position may be employed that are equally or more suitable.

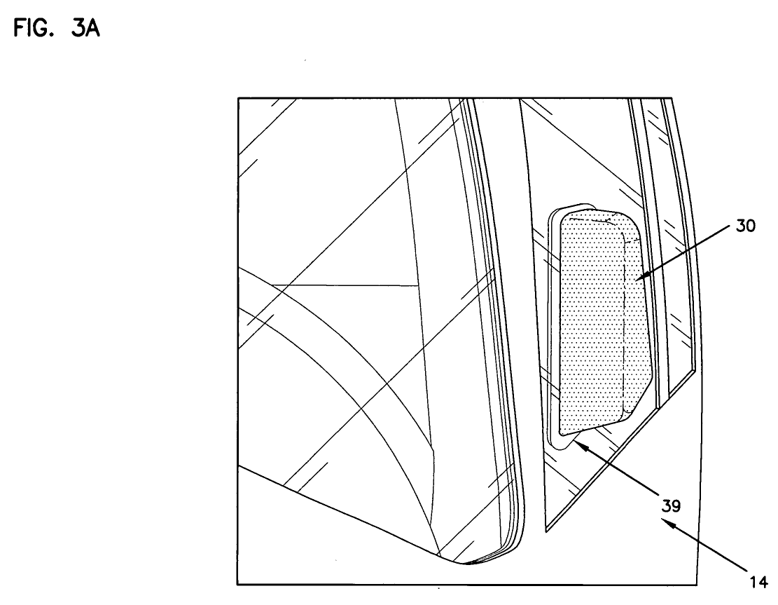

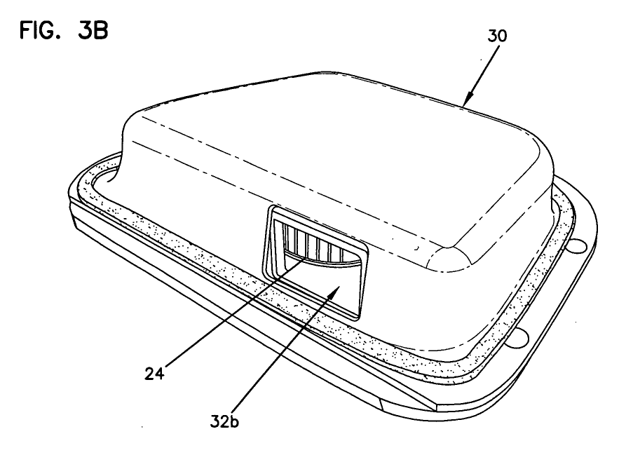

With reference to FIGS. 2-4, the exhaust fan 24 is removably mounted within the pilot window 20 when the window is opened. FIG. 2 shows the pilot window 20 swung inwardly into the interior of the aircraft. The exhaust fan 24 comprises a fan unit 28 and a fan housing 30. The fan unit 28 illustrated in FIG. 2 is a centrifugal fan in which air enters the fan axially through inlet 32a and is discharged radially through an outlet 32b (shown in FIG. 3B) in the housing 30 at the exterior of the aircraft. With reference to FIG. 3B, the outlet 32b is located at the bottom of the housing 30 which projects outwardly from the side of the aircraft to accommodate the size of the centrifugal fan. By locating the outlet 32b at the bottom of the housing, rain is prevented from entering the cockpit through the fan.

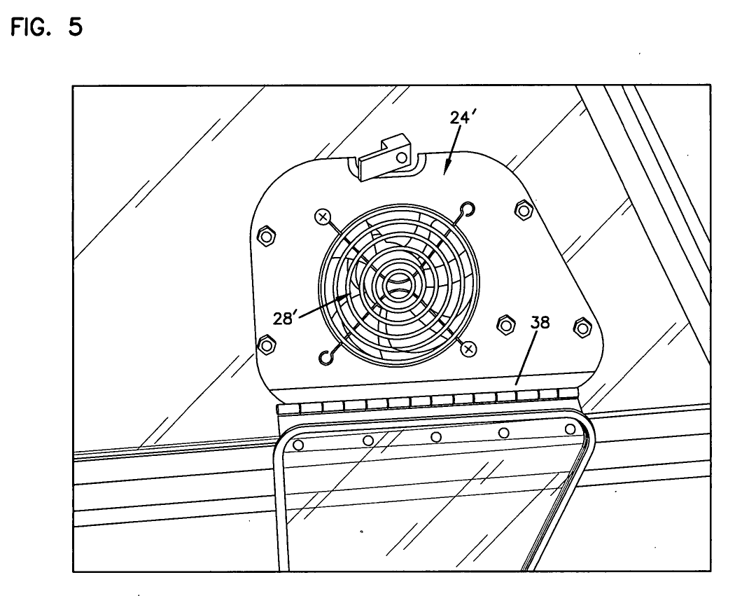

FIG. 5 shows an alternative exhaust fan 24′ in the form of a fan unit 28′ having an axial flow fan in which air enters and exits the fan axially. As with the fan 24, the outlet for the fan 24′ would be disposed at the bottom of the housing to prevent entry of rain. As a result, even though the air exits the fan unit 28′ axially, the air exits the fan 24′ radially through an outlet in the housing for the fan 24′.

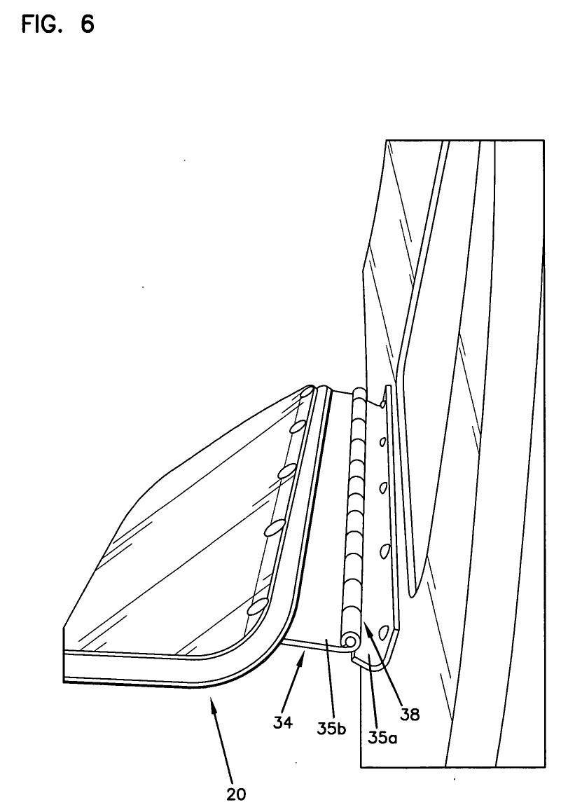

With reference to FIGS. 2, 4, and 6, the pilot window 20 comprises a piece of glass that is mounted by a hinge 34 for pivoting movement inward into the interior of the aircraft between the closed position shown in FIG. 4 and the open position shown in FIGS. 2 and 6. A pivoting latch mechanism 36 is provided inside the aircraft which can be pivoted from a first, release position to allow the pilot window 20 to be pivoted inward, and a second, latching position (shown in FIG. 4) at which it is disposed behind the pilot window in order to retain the pilot window 20 at the closed position.

The hinge 34 generally includes a first portion with an end that is hingedly connected with an end of a second portion. The first portion has another end connected to the window 16 and the second portion has another end connected to the pilot window 20. With reference to specifically to FIG. 6, the hinge 34 includes a first, J-shaped portion 35a connected to the window 16, a second portion 35b connected to the pilot window 20, and a hinge shaft that connects the first and second portions 35a, 35b. When the pilot window 20 is opened, a trough 38 is formed by the J-shaped portion 35a of the hinge 34. The bottom edge of the fan housing 30 is configured and sized to rest within the trough 38. This secures the bottom edge of the fan 24, 24′.

The upper edge of the fan housing 30 is retained by the latch mechanism 36 as shown in FIG. 2. The remainder of the housing 30 is configured and sized to substantially fill-up the entire opening of the pilot window 20. In the illustrated embodiment, the housing 30 is made larger than the actual opening, so that the housing 30 overlaps the edges of the opening. As one preferred example, the housing 30 includes an overlapping edge 39 resembling an outer flange or border, and that is sized and configured to overlap the edge of the opening of the pilot window 20. The overlapping edge 39 overlaps the edge of the opening at an interior surface of the window. This helps to retain the housing 30 in position and prevent air from leaking between the edges of the housing 30 and the opening. A seal, for example a strip of foam or rubber, is provided on the overlapping portions of the housing 30 to seal between the overlapping edge of the housing and the interior surface of the window to prevent water from leaking into the cockpit.

As a result of the mounting arrangement of the fan 24, 24′, the fan cannot be pushed outward due to the overlap between the housing 30 and the opening, and cannot be pushed inwards due to the trough 38 and the latch mechanism 36.

Electrical connection between the array 22 and the fan 24, 24′ is established by a suitable electrical cord assembly 40. The assembly 40 comprises a first cord 41 that connects to the array and that terminates in a 12 volt power point in the form of a female connector 42. A suitable cord 41 is available from Iowa Thin Film Technologies of Ames, Iowa. A second cord 44 is also provided that provides electrical connection between the cord 41 and the fan 24, 24′. The cord 44 is similar to a conventional fused 12 volt autoplug that is often used to plug into a vehicle cigarette lighter, where the cord 44 includes a male connector 46 and a right angle male plug 48 that connects into a jack provided in the fan 24, 24′. Because of the male connector 46, the fan unit 24, 24′ can be plugged into the electrical system of the aircraft through the cigarette lighter found on many general aviation aircraft.

It will be appreciated that the specific embodiment of the electrical connector assembly shown is exemplary only. Other electrical connector configurations may be employed that are equally or more suitable.

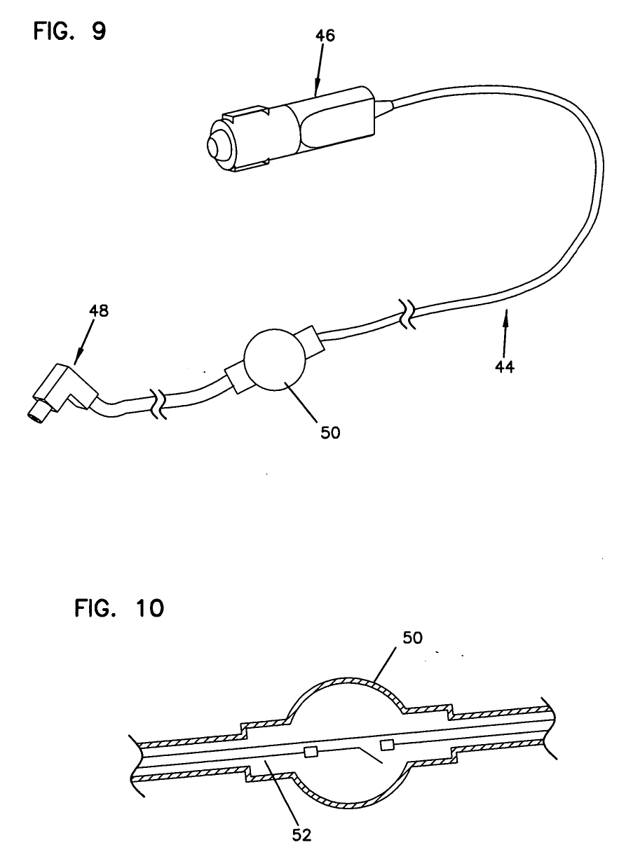

The cord 44 differs from a standard fused 12 volt autoplug in that a thermostat 50 is incorporated into the cord 44. FIG. 9 shows the thermostat incorporated into the cord 44, and FIG. 10 schematically depicts the electrical connection between the cord and the thermostat. The thermostat 50 comprises a circular disk electrically connected to one electrical wire 52 within the cord 44 and acting as a switch on that wire. A suitable thermostat is available from EAW Relaistechnik GmbH of Berlin, Germany and Portage Electric Products, Inc. of North Canton, Ohio. The thermostat 50 is encased in rubber or plastic after electrical connection with the cord 44 is established.

The thermostat in the cord 44 senses the air temperature inside the cockpit. If the temperature is below a predetermined set point, for example 80° F., electricity is prevented from flowing to the fan unit 24, 24′ thereby preventing the fan from turning on. Only when the cockpit temperature increases above the set point can the fan turn on. This prevents the fan from operating when the air temperature is at a level such that dew and other moisture may be pulled into the cockpit interior as a result of the creation of the negative pressure inside the cockpit. A thermostat can be incorporated at other locations of the system 10 other than the cord 44 if desired, for example in the fan housing, for performing a similar function.

Other than the thermostat 50, the fan unit 24, 24′ is turned off by unplugging the cord 44 from either the fan unit 24, 24′ or from the cord 40. When the array 22 is used outside the aircraft, a suitable plug-in jack for the male connector 48 will be provided on the portion of the housing 30 that is disposed outside the aircraft. This will permit electrical connection between the array and the fan unit without having to run the cord(s) inside the cockpit.

The system 10 is intended to be removed during flight. In this regard, the compact size of the array 22 and fan 24, 24′ allows the system 10 to be stored within the interior of the aircraft without taking up excessive space. Moreover, the system is light in weight so that it does not substantially diminish the aircraft's useful load. The removable mounting of the fan 24, 24′ allows the fan 24, 24′ to easily be inserted and removed in the pilot window.

The above specification provides a complete description of the composition, manufacture and use of the solar powered ventilation system in accordance with the principles of the present invention. Since many embodiments of the invention can be made without departing from the spirit and scope of the invention, the invention resides in the claims hereinafter appended.

1. A system for ventilating and cooling the interior space of a vehicle having at least one window, the system comprising:
an electrically powered exhaust fan configured to mount to the vehicle and having an inlet that is in communication with the interior space when mounted on the vehicle; and
an array of photovoltaic cells for generating electrical energy from sunlight, wherein the array may be electrically connected to the exhaust fan for providing electrical energy to the exhaust fan, and the array is sufficiently flexible so that it can be rolled up.

2. A system for ventilating and cooling the interior space of an aircraft having a cockpit and a plurality of windows, one of the windows having a portion that is moveable between an open and a closed position and creating an opening when in the open position, the system comprising:
an electrically powered exhaust fan configured to mount within the opening when the window portion is at the open position, the fan having an inlet that is in communication with the interior space when mounted within the opening and an outlet to the exterior of the aircraft; and
an array of photovoltaic cells for generating electrical energy from sunlight, wherein the array may be electrically connected to the exhaust fan for providing electrical energy to the exhaust fan.

3. The system according to claim 2, wherein the window portion comprises a piece of glass that is mounted by a hinge for pivoting movement relative to the one window.

4. The system according to claim 3, wherein the hinge includes a first portion with an end that is hingedly connected with an end of a second portion, the first portion having another end connected to the one window and the second portion having another end connected to the window portion, the second portion defining a J-shaped portion forming a trough, and a bottom edge of the exhaust fan is configured and sized to rest within the trough.

5. The system of claim 2, wherein the exhaust fan is configured to exhaust air from the interior space of the cockpit to the exterior of the aircraft, such that when the exhaust fan exhausts air from the interior space of the cockpit to the exterior of the aircraft, a negative pressure in the interior space is created, which draws in outside air into the interior space.

6. The system of claim 2, wherein the array of photovoltaic cells is disposed inside the cockpit and faces outward so as to be exposed to sunlight.

7. The system of claim 2, wherein the array of photovoltaic cells is disposed outside the cockpit and is positioned to be exposed to sunlight.

8. The system of claim 2, wherein the array of photovoltaic cells is flexible so that it can be rolled up.

9. The system of claim 2, wherein the exhaust fan is removably mountable within the opening when the window portion is opened.

10. The system of claim 2, wherein the inlet of the exhaust fan enables air to enter axially through the inlet from the interior space and is discharged radially through the outlet to the exterior of the aircraft.

11. The system of claim 2, wherein the exhaust fan is a centrifugal fan.

12. The system of claim 2, wherein the exhaust fan defines a fan housing, the outlet of the exhaust fan being disposed at a bottom portion of the fan housing, the bottom portion residing at the exterior of the aircraft when the exhaust fan is mounted within the opening.

13. The system of claim 12, wherein the fan housing defines an overlapping edge about an outer portion of the fan housing that is larger than the opening of the window, whereby the edge overlaps an outer edge of the opening of the window.

14. The system of claim 2, wherein the array of photovoltaic cells is electrically connectable with the exhaust fan by an electrical cord assembly, wherein the electrical cord assembly includes a thermostat electrically connected with the electrical cord assembly.

15. A method of ventilating the interior space of an aircraft having a cockpit and a plurality of windows, one of the windows having a portion that is moveable between an open and a closed position and creating an opening when in the open position, the method comprising:
mounting an electrically powered exhaust fan within the opening when the window portion is at the open position, the fan being mounted so that an inlet thereof is in communication with the interior space when mounted within the opening and an outlet thereof discharges to the exterior of the aircraft; and
electrically connecting the exhaust fan to an array of photovoltaic cells for generating electrical energy from sunlight.

16. The method of claim 15, comprising arranging the array of photovoltaic cells inside the cockpit and facing outward so as to be exposed to sunlight.

17. The method of claim 15, comprising arranging the array of photovoltaic cells outside the cockpit in a position to be exposed to sunlight.
